(19) United States
(12) Patent Application Publication
(10) Pub. No.: US 2026/0230428 A1
(43) Pub. Date: Aug. 6, 2026

(54) PROACTIVE LEARNING AND ADVERTISEMENT OF HOST ADDRESSES IN A MULTIHOMING GROUP OF AN ETHERNET VIRTUAL PRIVATE NETWORK

(71) Applicant: TELEFONAKTIEBOLAGET LM ERICSSON (PUBL), Stockholm (SE)

(72) Inventors: M Praveen Kumar, Bangalore (IN); Tulasi Rami Reddy N, Bangalore (IN)

(21) Appl. No.: 19/153,259

(22) PCT Filed: Feb. 2, 2023
(86) PCT No.: PCT/IN2023/050100

§ 371 Date: Aug. 1, 2025

(51) Int. Cl. H04L 45/741; H04L 12/46

(52) U.S. Cl. CPC H04L 45/741; H04L 12/4641

(57) ABSTRACT

Disclosed herein is a method performed by a first provider edge (PE) providing multihoming in an ethernet virtual private network (EVPN) to proactively learn and advertise host addresses in the EVPN. The method includes receiving a first address advertisement message from a second PE in the EVPN, wherein the first address advertisement message includes an internet protocol (IP) address associated with a host that is reachable via the second PE and an ethernet segment identifier identifying an ethernet segment, responsive to receiving the first address advertisement, sending an address resolution request message for the IP address via a local interface, and responsive to receiving an address resolution response message corresponding to the address resolution request message, sending a second address advertisement message to one or more remote PEs in the EVPN, wherein the second address advertisement message includes the media access control (MAC) address corresponding to the IP address.

### TECHNICAL FIELD

Embodiments of the invention relate to the field of computer networks, and more specifically to proactively learning and advertising host addresses in a multihoming group of an ethernet virtual private network (EVPN).

### BACKGROUND

Ethernet virtual private network (EVPN) is a technology for carrying layer 2 ethernet/IP (internet protocol) traffic as a virtual private network using wide area network protocols. EVPN technologies include ethernet over multi-protocol label switching (MPLS), ethernet over virtual extensible local area network (VXLAN), and ethernet over segment routing over IP version 6 (IPv6) dataplane (SRv6).

An EVPN instance may include customer edges (CEs) that are connected to provider edges (PEs) that form the edge of a network infrastructure. PEs may be connected to other PEs over a multiprotocol label switching (MPLS) infrastructure, which provides the benefits of MPLS technology, such as fast reroute and resiliency. Alternatively, PEs may be connected to other PEs over an internet protocol (IP) infrastructure, in which case generic routing encapsulation (GRE) tunneling, SRv6, or other IP tunneling can be used between the PEs. A CE may be a host, a router, or a switch. The PEs may provide virtual layer 2 bridged connectivity between the CEs. An EVPN may include multiple EVPN instances.

In EVPN, media access control (MAC) learning between PEs occurs in the control plane as opposed to the data plane. Control plane learning offers greater control over the MAC learning process such as restricting who learns what, as well as the ability to apply policies. Multi-protocol border gateway protocol (MP-BGP) is commonly used as the control plane protocol in EVPN for advertising MAC/IP reachability information. For example, PEs may advertise the MAC/IP addresses learned from the CEs that are connected to them, along with EVPN labels (e.g., a MPLS label) or a SRv6 segment identifier, to other PEs in the control plane using MP-BGP.

EVPN multihoming allows a CE to be connected to more than one PE. EVPN multihoming may provide load balancing, link/node redundancy, and fast convergence. Multihoming may operate in single-active redundancy mode or all-active redundancy mode. In single-active redundancy mode, only a single PE among a group of PEs attached to a particular ethernet segment is allowed to forward traffic to and from that ethernet segment. In all-active redundancy mode, all of the PEs attached to the particular ethernet segment are allowed to forward traffic to and from that ethernet segment.

In case of an all-active redundancy mode multihoming deployment, a CE may be connected to multiple PEs using a link aggregation group (LAG). The CE may LAG hash packets based on stream (e.g., using L2 and/or L3 information). LAG hashing of the particular packet stream by a multihomed CE can result in only one of the PEs in the multihoming group for the CE learning information regarding a host behind the CE (e.g., only one of the PEs will have an address resolution protocol (ARP) entry for the host). This in turn results in only one of the PEs in the multihoming group advertising the EVPN MAC/IP advertisement route (also referred to as an EVPN Type 2 route) for the given host to remote PEs. Thus, other remote PEs in the same EVPN instance will consider the host reachable only via the PE that advertised the MAC/IP advertisement route even though the host may also be reachable via other PEs in the multihoming group.

The above-described scenario may lead to suboptimal usage of network resources and defeats the purpose of having redundancy. It deprives the ability for PEs to perform equal cost multiple path (ECMP) routing to the host. Also, the other (non-advertising) PEs in the all-active redundancy mode multihoming group will not perform local switching to the CE but instead send received traffic destined for the host via the route advertised by the advertising PE. This causes traffic convergence issues when the advertising PE goes down, as it requires the other PEs in the multihoming group to learn about the host (e.g., using ARP), which introduces delays in convergence.

### SUMMARY

A method performed by a network device functioning as a first provider edge (PE) providing multihoming in an ethernet virtual private network (EVPN) to proactively learn and advertise host addresses in the EVPN is disclosed. The method includes receiving a first address advertisement message from a second PE in the EVPN, wherein the first address advertisement message includes an internet protocol (IP) address associated with a host that is reachable via the second PE and an ethernet segment identifier identifying an ethernet segment, responsive to receiving the first address advertisement message and determining that the first PE is attached to the ethernet segment identified by the ethernet segment identifier, sending an address resolution request message for the IP address included in the first address advertisement message via a local interface, receiving an address resolution response message corresponding to the address resolution request message via the local interface, wherein the address resolution response message includes a media access control (MAC) address corresponding to the IP address, and responsive to receiving the address resolution response message, sending a second address advertisement message to one or more remote PEs in the EVPN, wherein the second address advertisement message includes the MAC address corresponding to the IP address.

A non-transitory machine-readable storage medium is disclosed that provides instructions that, if executed by a processor of a network device implementing a first PE providing multihoming in an EVPN, will cause the first PE to perform operations for proactively learning and advertising host addresses in the EVPN. The operations include receiving a first address advertisement message from a second PE in the EVPN, wherein the first address advertisement message includes an IP address associated with a host that is reachable via the second PE and an ethernet segment identifier identifying an ethernet segment, responsive to receiving the first address advertisement message and determining that the first PE is attached to the ethernet segment identified by the ethernet segment identifier, sending an address resolution request message for the IP address included in the first address advertisement message via a local interface, receiving an address resolution response message corresponding to the address resolution request message via the local interface, wherein the address resolution response message includes a MAC address corresponding to the IP address, and responsive to receiving the address resolution response message, sending a second address advertisement message to one or more remote PEs in the EVPN, wherein the second address advertisement message includes the MAC address corresponding to the IP address.

A network device is disclosed to implement a first provider edge (PE) in an ethernet virtual private network (EVPN) that proactively learns and advertises host addresses in the EVPN when providing multihoming in the EVPN. The network device includes a set of one or more processors and a non-transitory machine-readable storage medium that provides instructions that, if executed by the set of one or more processors, will cause the first PE to receive a first address advertisement message from a second PE in the EVPN, wherein the first address advertisement message includes an IP address associated with a host that is reachable via the second PE and an ethernet segment identifier identifying an ethernet segment, responsive to receiving the first address advertisement message and determining that the first PE is attached to the ethernet segment identified by the ethernet segment identifier, send an address resolution request message for the IP address included in the first address advertisement message via a local interface, receive an address resolution response message corresponding to the address resolution request message via the local interface, wherein the address resolution response message includes a MAC address corresponding to the IP address, and responsive to receiving the address resolution response message, send a second address advertisement message to one or more remote PEs in the EVPN, wherein the second address advertisement message includes the MAC address corresponding to the IP address.

### BRIEF DESCRIPTION OF THE DRAWINGS

The invention may best be understood by referring to the following description and accompanying drawings that are used to illustrate embodiments of the invention. In the drawings:

FIG. 1 is a diagram showing an ethernet virtual private network (EVPN) system and operations therein to proactively learn and advertise host addresses in a multihoming group of the EVPN system, according to some embodiments.

FIG. 2 is a diagram showing components of a provider edge (PE), according to some embodiments.

FIG. 3 is a diagram showing PE interactions, according to some embodiments.

FIG. 4 is a flow diagram of a method for proactively learning and advertising host addresses in a multihoming group of an EVPN, according to some embodiments.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

### DETAILED DESCRIPTION

The following description describes methods and apparatus for proactively learning and advertising host addresses in a multihoming group of an ethernet virtual private network (EVPN). In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, link aggregation group (LAG) hashing by a multihomed customer edge (CE) can result in only one of the provider edges (PEs) in the multihoming group for the CE learning information regarding a host behind the CE (e.g., only one of the PEs will have an address resolution protocol (ARP) entry for the host). This results in only one of the PEs in the multihoming group advertising the EVPN MAC/IP (media access control/internet protocol) advertisement route (also referred to as an EVPN Type 2 route) for the given host to remote PEs. Other remote PEs in the same EVPN instance will consider the host reachable only via the PE that advertised the MAC/IP advertisement route even though the host may also be reachable via other PEs in the multihoming group.

Embodiments are disclosed herein that allow the other PEs in the multihoming group to proactively learn and advertise the MAC/IP advertisement route for a host behind the CE. This allows remote PEs (that are not part of the multihoming group) to reach the host via multiple PEs. Embodiments allow the remote PEs to leverage IP equal cost multiple path (ECMP) routing functionality when sending traffic to the host. Also, when one of the PEs in the multihoming group goes down, embodiments allow remote PEs to be able to immediately switch to sending traffic destined for the host to the other PEs in the multihoming group, thereby providing faster convergence. Embodiments allow all PEs in a multihoming group to have an entry to send traffic to the host behind the CE via a local interface irrespective of the LAG hashing result at the CE. This may help avoid having to send subsequent ARP requests when data traffic arrives. With embodiments, traffic destined for the host can be seamlessly received by any of the PEs in the multihoming group and forwarded to the host without traffic disruption. Thus, embodiments allow for a more efficient usage of network resources in EVPN multihoming scenarios.

According to embodiments, when a PE learns MAC/IP information about a host, the PE sends an EVPN MAC/IP advertisement route to all PEs in the EVPN instance, including the PEs that are part of the same multihoming group as the advertising PE. Upon receiving the EVPN MAC/IP advertisement route, the PEs that are in the same multihoming group as the advertising PE install a remote host route for the host IP address in a routing information base (RIB) with the advertising PE as the next hop. As a result, all data traffic received by the other PEs in the multihoming group and destined for the host will be rerouted to the advertising PE even though the other PEs in the multihoming group can reach the host using a local interface.

In order to use the local interface for sending traffic to the host, a local adjacency route (route learnt locally and forwarding is programmed to use attached local interface of the PE to the CE—also referred to as a local host route) for the host IP address should be installed in the other PEs in the all-active multihoming group instead of a remote host route (route learnt from remote PE and forwarding is programmed to use remote PE nexthop IP address). Embodiments achieve this by having the other PEs in the all-active multihoming group send an address resolution protocol (ARP) request message or neighbor solicitation (NS) message for the host IP address upon receiving the MAC/IP advertisement route from the first PE. The ARP request message or NS message may be sent using a PE's non-anycast IP address as the source IP address and the PE's hardware MAC address as the source hardware address to ensure that the corresponding ARP reply message or neighbor advertisement (NA) message is received by the PE that originated the ARP request message or NS message, and thereby ensure that the originating PE sends a MAC/IP advertisement route to remote PEs.

An embodiment is a method performed by a network device functioning as a first PE providing multihoming in an ethernet virtual private network (EVPN) to proactively learn and advertise host addresses in the EVPN. The method includes receiving a first address advertisement message from a second PE in the EVPN, wherein the first address advertisement message includes an IP address associated with a host that is reachable via the second PE and an ethernet segment identifier identifying an ethernet segment, responsive to receiving the first address advertisement message and determining that the first PE is attached to the ethernet segment identified by the ethernet segment identifier (e.g., which indicates that the first PE is part of the same multihoming group as the second PE), sending an address resolution request message for the IP address included in the first address advertisement message via a local interface, receiving an address resolution response message corresponding to the address resolution request message via the local interface, wherein the address resolution response message includes a MAC address corresponding to the IP address, and responsive to receiving the address resolution response message, sending a second address advertisement message to one or more remote PEs in the EVPN, wherein the second address advertisement message includes the MAC address corresponding to the IP address and performs local switching (directly on to local ethernet segment) to the host when traffic is received from the remote PE. Embodiments are further described herein with reference to the accompanying figures.

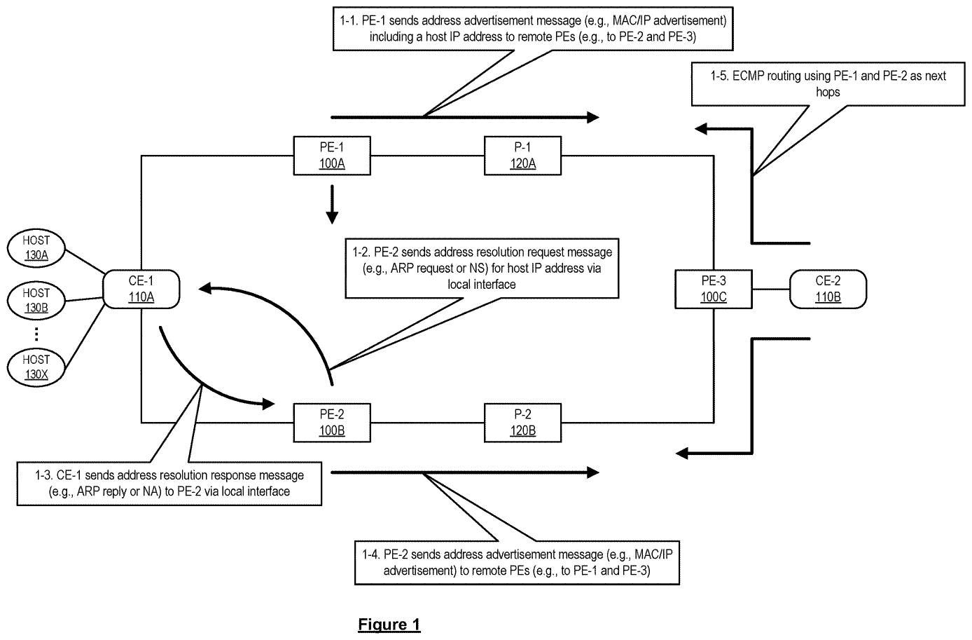

FIG. 1 is a diagram showing an EVPN system and operations therein to proactively learn and advertise host addresses in a multihoming group of the EVPN system, according to some embodiments.

As shown in the diagram, the EVPN system includes PE-1 100A, PE-2 100B, PE-3 100C, CE-1 110A, CE-2 110B, P-1 120A, P-2 120B, and hosts 130A-X. A CE 110 (e.g., CE-1 110A and CE-2 110B) may be, for example, a host, a router, or a switch. The PEs 100 (e.g., PE-1 100A, PE-2 100B, and PE-3 100C) may provide layer 2 virtual bridge/IP virtual private network (VPN) connectivity between the CEs 110. The PEs 100 may be communicatively coupled to other PEs over a multiprotocol label switching (MPLS) infrastructure, which provides the benefits of MPLS technology, such as fast reroute and resiliency. In other embodiments, the EVPN system may be implemented using other types of network virtualization overlay (NVO) infrastructures such as a virtual extensible local area network (VXLAN) infrastructure, a network virtualization using generic routing encapsulation (NVGRE) infrastructure, a generic network virtualization encapsulation (GENEVE) infrastructure, or a segment routing over IP version 6 (IPv6) dataplane (SRv6) infrastructure.

As shown in the diagram, CE-1 110A is multihomed to PE-1 100A and PE-2 100B. Thus, PE-1 100A and PE-2 100B are said to be part of the multihoming group for CE-1 110A. EVPN multihoming may allow for load balancing, link/node redundancy, and/or fast convergence. PE-1 100A and PE-2 100B may provide connectivity to CE-1 110A via an ethernet segment. The communication links connecting CE-1 110A to PE-1 100A and PE-2 100B may collectively form an ethernet segment. The ethernet segment may be uniquely identified using an ethernet segment identifier (ESI). In an embodiment, the ESI is a unique non-zero identifier that identifies an ethernet segment. In this example, the ethernet segment operates in all-active redundancy mode (as opposed to single-active redundancy mode). In all-active redundancy mode, all of the PEs 100 attached to the particular ethernet segment are allowed to forward traffic to and from that ethernet segment. Also, in this example, CE-2 110B is single-homed to PE-3 100C. Each of the PEs 100 and the CEs 110 may be implemented using one or more network devices.

Also, as shown in the diagram, CE-1 110A is communicatively coupled to hosts 130A-X. These hosts 130 are said to be “behind” CE-1 110A. The PEs 100 may be communicatively coupled to each other via provider (P) routers such as P-1 120A and P-2 120B. The P routers 120 may facilitate communications between PEs 100.

While the diagram shows the EVPN system as having a particular arrangement, it should be appreciated that the EVPN system can have a different arrangement than shown in the diagram (e.g., the EVPN system may include additional PEs 100, additional CEs 110, and/or other network components). Thus, the particular arrangement shown in the diagram should be regarded as illustrative and not limiting.

Example operations for proactively learning and advertising host addresses in a multihoming group of the EVPN system will now be described with reference to the diagram. At operation 1-1, upon learning information about a host 130 (e.g., host 130A) behind CE-1 110A, PE-1 100A sends an address advertisement message including the host IP address (e.g., the IP address associated with host 130A) to remote PEs (e.g., to PE-2 100B and PE-3 100C). In an embodiment, the address advertisement message is a MP-BGP message that includes a MAC/IP advertisement route (also referred to as an EVPN Type 2 route). Upon receiving the address advertisement message from PE-1 100A, PE-3 100C may install a remote host route for the host IP address in its routing information base (RIB) with PE-1 100A as the next hop. At operation 1-2, upon receiving the address advertisement message from PE-1 100A and determining that it is part of the same multihoming group as PE-1 100A, PE-2 100B sends an address resolution request message for the host IP address via its local interface (towards CE-1 110A) using non anycast IP address and hardware MAC of PE-2 100B as the source address in the address resolution request message (e.g., to ensure that PE-2 100B receives the corresponding address resolution response message). In an embodiment, the address resolution request message is an ARP request message or a NS message. At operation 1-3, the host (e.g., host 130A) sends an address resolution response message (corresponding to the address resolution request message sent by PE-2 100B at operation 1-2) and CE-1 110A sends (via switching) the address resolution response message to PE-2 100B (which may be received by PE-2 100B at its local interface). The address resolution response message may include the MAC address corresponding to the host IP address. In an embodiment, the address resolution response message is an ARP reply message or a NA message. At operation 1-4, upon receiving the address resolution response message from CE-1 110A, PE-2 100B sends an address advertisement message including the host MAC address and host IP address to remote PEs (e.g., to PE-1 100A and PE-3 100C). Upon receiving the address advertisement message from PE-2 100B, PE-3 100C installs a remote host route for the IP address in its RIB with PE-2 100B as the next hop. As a result, in this example, PE-3 100C will have a remote host route for the host IP address in its RIB with both PE-1 100A and PE-2 100B as next hops. Thus, at operation 1-5, PE-3 100C can now send traffic received from CE-2 110B that is destined for the host IP address using ECMP routing using PE-1 100A and PE-2 100B as next hops. Also, since PE-3 100C has multiple remote host routes to reach the host 130, PE-3 100C can quickly reach convergence when one of the PEs 100 in the multihoming group for CE-1 110A goes down. Also, when PE-2 100B receives traffic destined for the host IP address, it can send the traffic to the host 130 using local switching (instead of having to reroute the traffic to PE-1 100A, as done in conventional EVPN systems).

For the sake of illustration, the diagram shows CE-1 110A being multihomed to two PEs 100 (i.e., PE-1 100A and PE-2 100B). It should be appreciated, however, that CE-1 110A can be multihomed to more than two PEs 100. In such a case, the PEs 100 that are part of the same multihoming group for CE-1 110A may perform similar operations as PE-2 100B described above to proactively learn about the host 130 and send an address advertisement message to remote PEs, which can provide additional redundancy and confer similar benefits as mentioned above such as ECMP routing, fast convergence, and local switching.

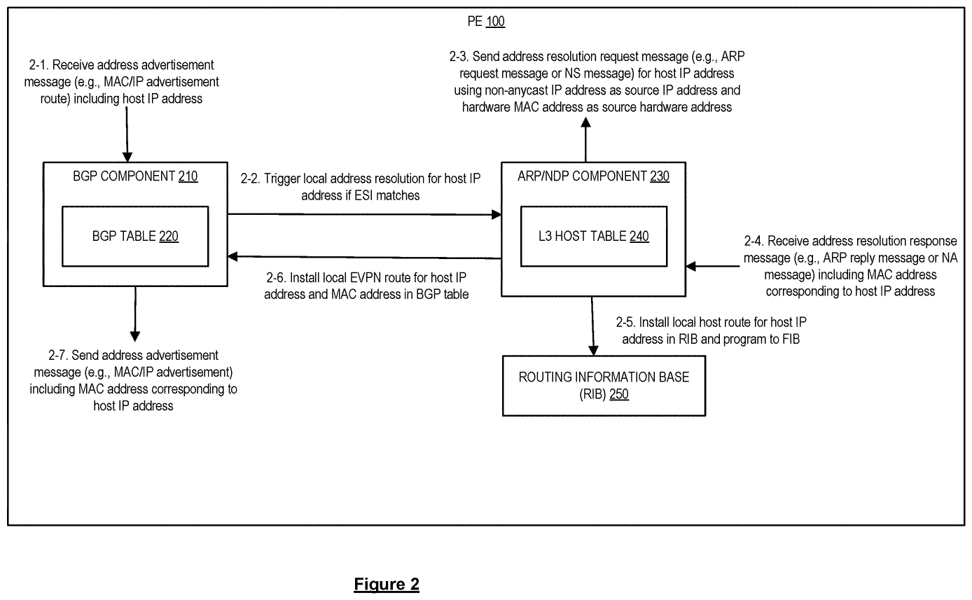

FIG. 2 is a diagram showing components of a PE, according to some embodiments.

As shown in the diagram, the PE 100 includes a BGP component 210, an ARP/NDP component 230, and a RIB 250. The BGP component 210 may be configured to perform operations in accordance with MP-BGP or similar protocol. The BGP component 210 may maintain a BGP table 220. The BGP table 220 may include information regarding EVPN routes such as MAC addresses, IP addresses, label information (e.g., multiprotocol label switching (MPLS) labels) SRv6 segment identifier, and/or ESIs. The ARP/NDP component 230 may be configured to perform operations in accordance with ARP and/or NDP or similar protocol. The ARP/NDP component 230 may maintain a L3 host table 240. The L3 host table 240 may include information regarding ARP/NDP routes such as IP addresses, MAC addresses, and local outgoing interfaces. The RIB 250 may store layer 3 routing information (e.g., IP routing information) such as mappings between IP addresses and outgoing interfaces. While certain components and arrangement of components are shown in the diagram, it should be understood that different arrangements are possible to achieve similar/same functionality.

Example operations for proactively learning and advertising host addresses in a multihoming group of the EVPN system will now be described with reference to the diagram. At operation 2-1, the BGP component 210 receives an address advertisement message that includes a host IP address. In an embodiment, the address advertisement message is an MP-BGP message that includes a MAC/IP advertisement route. At operation 2-2, the BGP component 210 triggers the ARP/NDP component 230 to perform local address resolution for the host IP address if the ESI included in the address advertisement message matches the ESI of an ethernet segment attached to the PE 100 (which means that the PE 100 and the advertising PE are part of the same multihoming group for a CE) and the ethernet segment operates in all-active redundancy mode. At operation 2-3, the ARP/NDP component 230 sends an address resolution request message (e.g., an ARP request message or NS message) for the host IP address to check host liveliness (e.g., ARP/NDP entry may be set to the “probe” state at this stage). The address resolution request message may be sent using a non-anycast (integrated routing and bridging (IRB)) IP address of the PE 100 as the source IP address and the hardware MAC address (of the IRB interface) of the PE 100 as the source hardware address. This may ensure that the PE 100 (and not another PE that is part of the same multihoming group) receives the corresponding address resolution response message. The PE 100 may have a non-anycast IP address configured on an IRB interface in the same IP subnet. This is typically available as an OAM (operations, administration, and management) IP address (e.g., as described in RFC (request for comment) 9135). At operation 2-4, the ARP/NDP component 230 receives an address resolution response message corresponding to the address resolution request message (e.g., an ARP reply message or NA message) including the MAC address corresponding to the host IP address (e.g., ARP/NDP entry may be set to the “active” (or equivalent/similar) state at this stage). The address resolution response message may be sent to the PE 100 as a unicast packet. The ARP/NDP component 230 creates a L3 host entry in the L3 host table 240 in response to receiving the address resolution response message. At operation 2-5, the ARP/NDP component 230 installs a local host route for the host IP address (e.g., pointing to a local IRB interface) in the RIB 250. The ARP/NDP component 230 may use the RIB 250 to program the route in a hardware forwarding information base (FIB) (not shown in the diagram). At operation 2-6, the ARP/NDP component 230 causes the BGP component 210 to install a local EVPN route for the host IP address and MAC address in the BGP table 220. The local EVPN route for the host IP/MAC address may be installed with the same sequence number in the MAC mobility extended community attribute as the route advertised by the other PE (the route that was advertised in operation 2-1). This local EVPN route may exist until the ARP/NDP component 230 causes it to be withdrawn locally (e.g., based on local age-out or IRB interface being down). At operation 2-7, the BGP component 210 sends an address advertisement message including the MAC address corresponding to the host IP address (e.g., a MP-BGP message that includes a MAC/IP advertisement route) to remote PEs in the same EVPN instance. This may cause the remote PEs to install a remote host route for the host IP address with the PE 100 as the next hop.

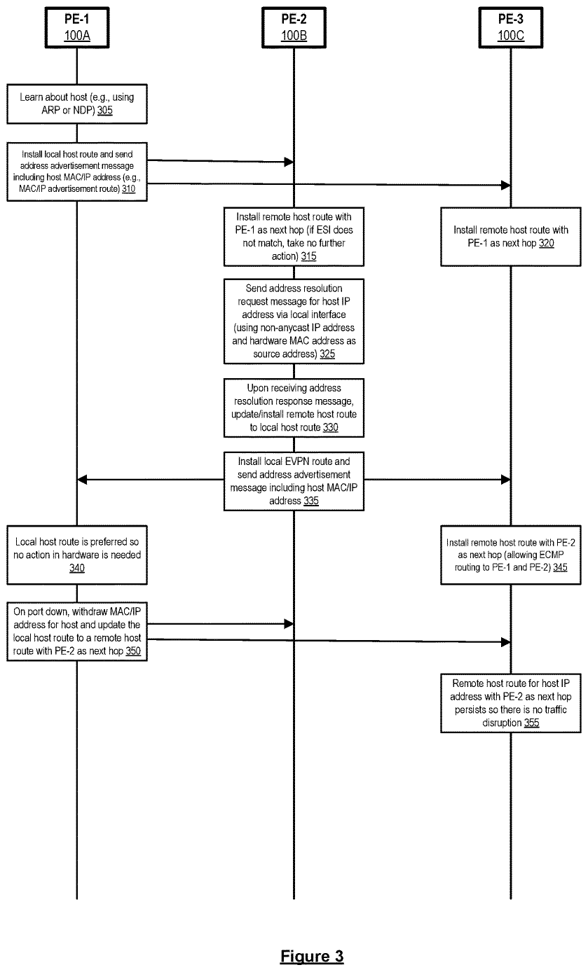

FIG. 3 is a diagram showing PE interactions, according to some embodiments.

At operation 305, PE-1 100A learns information about a host (e.g., using ARP or NDP). At operation 310, PE-1 100A installs a local host route for the host IP address in a RIB and FIB and sends an address advertisement message including the host MAC/IP address to PE-2 100B and PE-3 100C (e.g., the address advertisement message may be a MP-BGP message including a MAC/IP advertisement route).

At operation 315, upon receiving the address advertisement message, PE-2 100B installs a remote host route for the host IP address with PE-1 100A as the next hop. If the ESI included in the address advertisement message does not match the ESI of an ethernet segment attached to PE-2 100B (which means that PE-2 100B is not part of the same multihoming group as PE-1 100A), then PE-2 100B would take no further action. In this example, however, it is assumed that the ESI matches. At operation 320, PE-3 100C also installs a remote host route for the host IP address with PE-1 100A as the next hop.

At operation 325, PE-2 100B sends an address resolution request message (e.g., an ARP request message or NS message) for the host IP address via a local interface. PE-2 100B may send the address resolution request using PE-2's non-anycast IP address and hardware MAC address as the source IP address and source hardware address, respectively. At operation 330, upon receiving an address resolution response message (e.g., an ARP reply message or NA message) that includes the host MAC address (which means address resolution was successful), PE-2 100B updates/installs the remote host route installed in the RIB to a local host route (such that PE-2 100B will send any received traffic destined for the host IP address via its local interface). At operation 335, PE-2 100B installs a local EVPN route for the host MAC/IP address and sends an address advertisement message including the host MAC/IP address to PE-1 100A and PE-3 100C. The example shown in the diagram assumes that the address resolution was successful. If the address resolution was unsuccessful, then PE-2 100B would keep the remote host route (with PE-1 100A as next hop) and PE-2 100B would send/reroute any received traffic destined for the host IP address to PE-1 100A.

At operation 340, upon receiving the address advertisement message from PE-2 100B, PE-1 100A takes no action in hardware since the already installed local host route is preferred. At operation 345, upon receiving the address advertisement message from PE-2 100B, PE-3 100C installs a remote host route for the host IP address with PE-2 100B as the next hop. This allows PE-3 100C to use ECMP routing, with PE-1 100A and PE-2 100B as next hops, when sending traffic to the host.

At operation 350, upon detecting that the port is down (the host cannot be reached), PE-1 100A sends a message to PE-2 100B and PE-3 100C indicating that the host MAC/IP address is being withdrawn and updates the local host route for the host IP address to a remote host route with PE-2 100B as the next hop (e.g., PE-1 100A may have remembered that the route via PE-2 100B is the next best route).

At operation 355, PE-3 100C can still send traffic destined for the host IP address to PE-2 100B since the remote host route for the host IP address with PE-2 100B as the next hop persists. Thus, there is fast convergence and no/minimal traffic disruption.

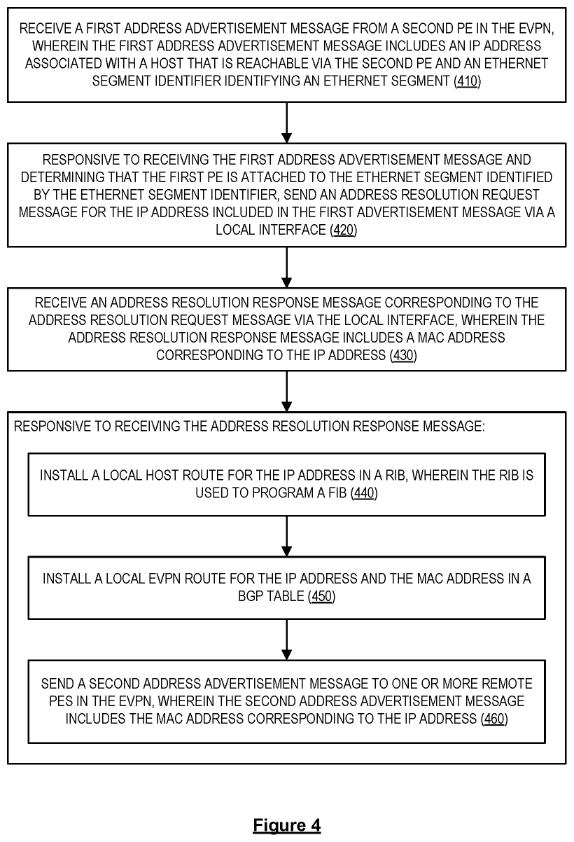

FIG. 4 is a flow diagram of a method for proactively learning and advertising host addresses in a multihoming group of an EVPN, according to some embodiments. In an embodiment, the method is implemented by a network device functioning as a first PE in an EVPN (e.g., PE-2 100B shown in FIG. 1).

The operations in the flow diagram will be described with reference to the exemplary embodiments of the other figures. However, it should be understood that the operations of the flow diagram can be performed by embodiments other than those discussed with reference to the other figures, and the embodiments discussed with reference to these other figures can perform operations different than those discussed with reference to the flow diagram.

Also, while the flow diagrams in the figures show a particular order of operations performed by certain embodiments, it should be understood that such order is provided by way of example and not intended to be limiting (e.g., alternative embodiments may perform the operations in a different order, combine certain operations, overlap certain operations, etc.).

At operation 410, the first PE receives a first address advertisement message from a second PE in the EVPN, wherein the first address advertisement message includes an IP address associated with a host that is reachable via the second PE and an ethernet segment identifier identifying an ethernet segment (e.g., the ethernet segment that the second PE can use to reach the host).

At operation 420, responsive to receiving the first address advertisement message and determining that the first PE is attached to the ethernet segment identified by the ethernet segment identifier, the first PE sends an address resolution request message for the IP address included in the first address advertisement message via a local interface. In an embodiment, the address resolution request message is sent using a non-anycast IP address associated with the first PE as a source IP address and a hardware MAC address associated with the first PE as a source hardware address. In an embodiment, the ethernet segment operates in an all-active redundancy mode.

At operation 430, the first PE receives an address resolution response message corresponding to the address resolution request message via the local interface, wherein the address resolution response message includes a MAC address corresponding to the IP address. In an embodiment, the address resolution request message is an ARP request message and the address resolution response message is an ARP reply message. In an embodiment, the address resolution request message is a NS message and the address resolution response message is a NA message.

In an embodiment, responsive to receiving the first address advertisement message, the first PE installs a remote host route for the IP address in a RIB with the second PE as a next hop. Subsequently, responsive to receiving the address resolution response message, the first PE updates the remote host route for the IP address to a local host route.

In an embodiment, responsive to receiving the address resolution response message, the first PE may perform one or more of operations 440-460.

At operation 440, the first PE installs a local host route for the IP address in a RIB. The RIB may then be used to program a FIB (in hardware).

At operation 450, the first PE installs a local EVPN route for the IP address and the MAC address in a BGP table.

At operation 460, the first PE sends a second address advertisement message to one or more remote PEs in the EVPN, wherein the second address advertisement message includes the MAC address corresponding to the IP address. In an embodiment, the second address advertisement message is a MP-BGP message including a MAC/IP advertisement route.

In an embodiment, sending the second address advertisement message to the one or more remote PEs causes each of the one or more remote PEs to install a remote host route for the IP address with both the first PE and the second PE as next hops. In such an embodiment, the one or more remote PEs may perform ECMP routing for traffic destined for the IP address using the first PE and the second PE as next hops. Also, in such an embodiment, the one or more remote PEs may quickly reconverge to send traffic destined for the IP address to the first PE but not the second PE when the one or more remote PEs determine that the second PE is down (and vice versa).

In an embodiment, when the first PE receives traffic destined for the IP address from a remote PE in the EVPN, the first PE sends the traffic destined for the IP address to the host using local switching.

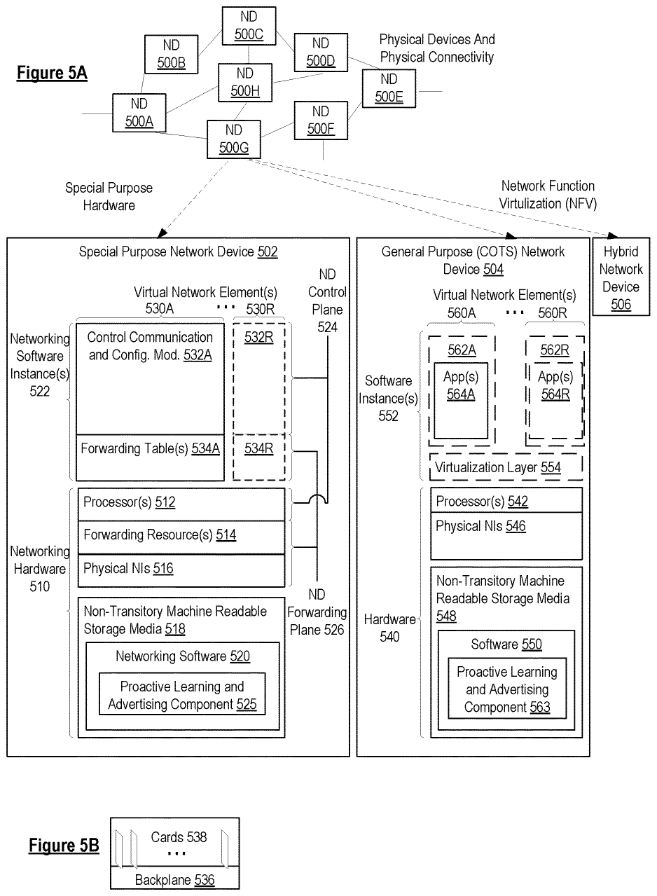

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between 500A-500B, 500B-500C, 500C-500D, 500D-500E, 500E-500F, 500F-500G, and 500A-500G, as well as between 500H and each of 500A, 500C, 500D, and 500G. These NDs are physical devices, and the connectivity between these NDs can be wireless or wired (often referred to as a link). An additional line extending from NDs 500A, 500E, and 500F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated circuits (ASICs) and a special-purpose operating system (OS); and 2) a general purpose network device 504 that uses common off-the-shelf (COTS) processors and a standard OS.

The special-purpose network device 502 includes networking hardware 510 comprising a set of one or more processor(s) 512, forwarding resource(s) 514 (which typically include one or more ASICs and/or network processors), and physical network interfaces (NIs) 516 (through which network connections are made, such as those shown by the connectivity between NDs 500A-H), as well as non-transitory machine readable storage media 518 having stored therein networking software 520. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

In an embodiment, software 520 includes code such as proactive learning and advertising component 525, which when executed by networking hardware 510, causes the special-purpose network device 502 to perform operations of one or more embodiments disclosed herein as part of networking software instances 522 (e.g., operations to proactively learn and advertise host addresses in an EVPN).

The special-purpose network device 502 is often physically and/or logically considered to include: 1) a ND control plane 524 (sometimes referred to as a control plane) comprising the processor(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the processor(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and physical NIs 546, as well as non-transitory machine readable storage media 548 having stored therein software 550. During operation, the processor(s) 542 execute the software 550 to instantiate one or more sets of one or more applications 564A-R. While one embodiment does not implement virtualization, alternative embodiments may use different forms of virtualization. For example, in one such alternative embodiment the virtualization layer 554 represents the kernel of an operating system (or a shim executing on a base operating system) that allows for the creation of multiple instances 562A-R called software containers that may each be used to execute one (or more) of the sets of applications 564A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 554 represents a hypervisor (sometimes referred to as a virtual machine monitor (VMM)) or a hypervisor executing on top of a host operating system, and each of the sets of applications 564A-R is run on top of a guest operating system within an instance 562A-R called a virtual machine (which may in some cases be considered a tightly isolated form of software container) that is run on top of the hypervisor-the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 540, directly on a hypervisor (in which case the unikernel is sometimes described as running within a LibOS virtual machine), or in a software container, embodiments can be implemented fully with unikernels running directly on a hypervisor represented by virtualization layer 554, unikernels running within software containers represented by instances 562A-R, or as a combination of unikernels and the above-described techniques (e.g., unikernels and virtual machines both run directly on a hypervisor, unikernels and sets of applications that are run in different software containers).

The instantiation of the one or more sets of one or more applications 564A-R, as well as virtualization if implemented, are collectively referred to as software instance(s) 552. Each set of applications 564A-R, corresponding virtualization construct (e.g., instance 562A-R) if implemented, and that part of the hardware 540 that executes them (be it hardware dedicated to that execution and/or time slices of hardware temporally shared), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 562A-R to VNEs also apply to embodiments where such a finer level of granularity and/or unikernels are used.

In certain embodiments, the virtualization layer 554 includes a virtual switch that provides similar forwarding services as a physical Ethernet switch. Specifically, this virtual switch forwards traffic between instances 562A-R and the physical NI(s) 546, as well as optionally between the instances 562A-R; in addition, this virtual switch may enforce network isolation between the VNEs 560A-R that by policy are not permitted to communicate with each other (e.g., by honoring virtual local area networks (VLANs)).

In an embodiment, software 550 includes code such as proactive learning and advertising component 563, which when executed by processor(s) 542, causes the general purpose network device 504 to perform operations of one or more embodiments described herein as part of software instances 562A-R (e.g., operations to proactively learn and advertise host addresses in an EVPN).

The third exemplary ND implementation in FIG. 5A is a hybrid network device 506, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VoD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method performed by a network device functioning as a first provider edge (PE) providing multihoming in an ethernet virtual private network (EVPN) to proactively learn and advertise host addresses in the EVPN, the method comprising:
receiving a first address advertisement message from a second PE in the EVPN, wherein the first address advertisement message includes an internet protocol (IP) address associated with a host that is reachable via the second PE and an ethernet segment identifier identifying an ethernet segment;
responsive to receiving the first address advertisement message and determining that the first PE is attached to the ethernet segment identified by the ethernet segment identifier, sending an address resolution request message for the IP address included in the first address advertisement message via a local interface;
receiving an address resolution response message corresponding to the address resolution request message via the local interface, wherein the address resolution response message includes a media access control (MAC) address corresponding to the IP address; and
responsive to receiving the address resolution response message, sending a second address advertisement message to one or more remote PEs in the EVPN, wherein the second address advertisement message includes the MAC address corresponding to the IP address.

2. The method of claim 1, wherein the second address advertisement message is a Multi-Protocol Border Gateway Protocol (MP-BGP) message including a MAC/IP advertisement route.

3. The method of claim 1, wherein the address resolution request message is an Address Resolution Protocol (ARP) request message and the address resolution response message is an ARP reply message.

4. The method of claim 1, wherein the address resolution request message is a Neighbor Solicitation (NS) message and the address resolution response message is a Neighbor Advertisement (NA) message.

5. The method of claim 1, wherein the address resolution request message is sent using a non-anycast IP address associated with the first PE as a source IP address and a hardware MAC address associated with the first PE as a source hardware address.

6. The method of claim 1, further comprising:
responsive to receiving the address resolution response message, installing a local EVPN route for the IP address and the MAC address corresponding to the IP address in a border gateway protocol (BGP) table.

7. The method of claim 1, further comprising:
responsive to receiving the address resolution response message, installing a local host route for the IP address in a routing information base (RIB), wherein the RIB is used to program a forwarding information base (FIB).

8. The method of claim 1, further comprising:
responsive to receiving the first address advertisement message, installing a remote host route for the IP address in a routing information base (RIB) with the second PE as a next hop; and
responsive to receiving the address resolution response message, updating the remote host route for the IP address to a local host route.

9. The method of claim 1, wherein the ethernet segment operates in an all-active redundancy mode.

10. The method of claim 1, wherein sending the second address advertisement message to the one or more remote PEs causes each of the one or more remote PEs to install a remote host route for the IP address with both the first PE and the second PE as next hops.

11. The method of claim 10, wherein the one or more remote PEs perform equal cost multiple path (ECMP) routing for traffic destined for the IP address using the first PE and the second PE as next hops.

12. The method of claim 10, wherein the one or more remote PEs can quickly reconverge to send traffic destined for the IP address to the first PE but not the second PE when the one or more remote PEs determine that the second PE is down.

13. The method of claim 1, further comprising:
receiving traffic destined for the IP address from a remote PE in the EVPN; and
sending the traffic destined for the IP address to the host using local switching.

14. A non-transitory machine-readable storage medium that provides instructions that, if executed by a processor of a network device implementing a first provider edge (PE) providing multihoming in an ethernet virtual private network (EVPN), will cause the first PE to perform operations for proactively learning and advertising host addresses in the EVPN, the operations comprising:
receiving a first address advertisement message from a second PE in the EVPN, wherein the first address advertisement message includes an internet protocol (IP) address associated with a host that is reachable via the second PE and an ethernet segment identifier identifying an ethernet segment;
responsive to receiving the first address advertisement message and determining that the first PE is attached to the ethernet segment identified by the ethernet segment identifier, sending an address resolution request message for the IP address included in the first address advertisement message via a local interface;
receiving an address resolution response message corresponding to the address resolution request message via the local interface, wherein the address resolution response message includes a media access control (MAC) address corresponding to the IP address; and
responsive to receiving the address resolution response message, sending a second address advertisement message to one or more remote PEs in the EVPN, wherein the second address advertisement message includes the MAC address corresponding to the IP address.

15. The non-transitory machine-readable storage medium of claim 14, wherein the second address advertisement message is a Multi-Protocol Border Gateway Protocol (MP-BGP) message including a MAC/IP advertisement route.

16. The non-transitory machine-readable storage medium of claim 14, wherein the address resolution request message is an Address Resolution Protocol (ARP) request message and the address resolution response message is an ARP reply message.

17. The non-transitory machine-readable storage medium of claim 14, wherein the address resolution request message is a Neighbor Solicitation (NS) message and the address resolution response message is a Neighbor Advertisement (NA) message.

18. A network device to implement a first provider edge (PE) in an ethernet virtual private network (EVPN) that proactively learns and advertises host addresses in the EVPN when providing multihoming in the EVPN, the network device comprising:
a set of one or more processors; and
a non-transitory machine-readable storage medium that provides instructions that, if executed by the set of one or more processors, will cause the first PE to:
receive a first address advertisement message from a second PE in the EVPN, wherein the first address advertisement message includes an internet protocol (IP) address associated with a host that is reachable via the second PE and an ethernet segment identifier identifying an ethernet segment,
responsive to receiving the first address advertisement message and determining that the first PE is attached to the ethernet segment identified by the ethernet segment identifier, send an address resolution request message for the IP address included in the first address advertisement message via a local interface,
receive an address resolution response message corresponding to the address resolution request message via the local interface, wherein the address resolution response message includes a media access control (MAC) address corresponding to the IP address, and
responsive to receiving the address resolution response message, send a second address advertisement message to one or more remote PEs in the EVPN, wherein the second address advertisement message includes the MAC address corresponding to the IP address.

19. The network device of claim 18, wherein the second address advertisement message is a Multi-Protocol Border Gateway Protocol (MP-BGP) message including a MAC/IP advertisement route.

20. The network device of claim 18, wherein the address resolution request message is sent using a non-anycast IP address associated with the first PE as a source IP address and a hardware MAC address associated with the first PE as a source hardware address.
